(19) United States
(12) Patent Application Publication
(10) Pub. No.: US 2025/0256883 A1
(43) Pub. Date: Aug. 14, 2025

(54) CORRUGATE COOLER

(71) Applicant: The Coleman Company, Inc., Wichita, KS (US)

(72) Inventors: Mark Elliott, Newton, KS (US); Powell Henderson, Charlotte, NC (US); Judson Gibbs, Huntersville, NC (US)

(21) Appl. No.: 18/702,494

(22) PCT Filed: Oct. 28, 2022
(86) PCT No.: PCT/US2022/078845

§ 371 Date: Apr. 18, 2024

Related U.S. Application Data
(60) Provisional application No. 63/274,625, filed on Nov. 2, 2021.

(51) Int. Cl. B65D 5/24; B31B 50/26; B31B 120/10; B31B 120/70; B65D 5/40; B65D 5/46; B65D 5/56; B65D 5/68

(52) U.S. Cl. CPC B65D 5/244; B31B 50/262; B65D 5/247; B65D 5/40; B65D 5/46072; B65D 5/563; B65D 5/68; B31B 2120/10; B31B 2120/70

(57) ABSTRACT

A disposable cooler is provided that, when assembled, is curbside recyclable. Tire cooler includes a lid portion and a. container to which the lid portion is selectively engageable. When the cooler is assembled, it may be watertight such that water does not leak from the bottom and includes handles for easy carrying and transport. The container uses a fully permeable substrate coating on its recyclable corrugate surface that allows it to be curbside recyclable. Neither glue nor fasteners are needed to keep the container or lid portion in place once they are assembled.

### CROSS-REFERENCE TO RELATED APPLICATIONS

The present application claims priority to U.S. Provisional Patent Application Ser. No. 63/274,635, filed Nov. 2, 2021, the entire contents of which are hereby incorporated by reference.

### FIELD OF INVENTION

The present invention relates to a cooler made from a corrugate material that can be used for multiple short term uses. The corrugate cooler of the present invention is preferably curbside recyclable.

### BACKGROUND OF INVENTION

Consumers use coolers to keep food or beverages cold. Coolers are often taken on picnics, camping trips, and other outdoor (or sometimes indoor) excursions so that consumers can enjoy the cool contents stored in the cooler away from the luxury of a refrigerator. Typically, ice cubes are placed in the cooler to help the contents inside stay cool. Ice packs are also sometimes used to keep the contents cool.

Coolers can be made to be durable for frequent, repeated uses, or they may be made to be disposable. As of late, disposable coolers have gained popularity due to their low prices, ease of storage, and convenience. Disposable coolers have historically been made from polystyrene foam that is approximately one inch thick. Unfortunately, the foam disposable coolers are especially hard on the environment, since such foam coolers do not biodegrade and can occupy landfill space for long periods of time.

Recently, disposable coolers have been made from a corrugate cardboard. Unfortunately, those disposable coolers are also detrimental to the environment. They are not truly recyclable. They are often coated with a wax material that prevents them from being recyclable. Further, they often come pre-assembled, so storing them can be a challenge. Yet other cardboard corrugate coolers are constructed such that they are not watertight, and as such they leak water as ice contained in the cooler melts. An easily storable, recyclable, and watertight cooler is desired that can be used several times before it needs to be recycled.

### SUMMARY OF INVENTION

The present invention provides a disposable cooler that overcomes the shortcomings in the prior art. More particularly, the disposable cooler hereof is a corrugate cooler that provides the consumer with a curbside recyclable solution for a short-term multi-use cooler.

The cooler of the present disclosure uses a fully permeable substrate coating on its recyclable corrugate surface that allows it to be curbside recyclable. The cooler generally includes each of a container and a lid portion, wherein the lid portion is selectively engageable with the container. Preferably, neither glue nor fasteners are needed to keep the container or lid portion in place once they are assembled.

The cooler is folded in such a way to make a watertight container. Furthermore, when the cooler is assembled, it includes handles for easy carrying and transport. The cooler, while disposable, is durable enough to withstand several uses.

These and other aspects and advantages of the present invention will become apparent to those skilled in the art after considering the following detailed description in connection with the accompanying drawings.

### BRIEF DESCRIPTION OF DRAWINGS

FIG. 1 is a side elevation view of a cooler constructed according to the teachings of the present invention.

FIG. 2 is a plan view of a container of the cooler of FIG. 1 in an unfolded position.

FIG. 3 is a partial view of the container of FIG. 2.

FIG. 4 illustrates a first step in constructing the container of FIGS. 2 and 3.

FIG. 5 illustrates a second step in constructing the container of FIGS. 2-4.

FIG. 6 illustrates a third step in constructing the container of FIGS. 2-5.

FIG. 7 illustrates a fourth step in constructing the container of FIGS. 2-6.

FIG. 8 illustrates a fifth step in constructing the container of FIGS. 2-7.

FIG. 9 illustrates a final step in constructing the container of FIGS. 2-8.

FIG. 10 illustrates a plan view of a lid portion of the cooler of FIG. 1 in an unfolded position.

FIG. 11 illustrates a first step in constructing the lid portion of FIG. 10.

FIG. 12 illustrates a second step in constructing the lid portion of FIGS. 10 and 11.

FIG. 13 illustrates a third step in constructing the lid portion of FIGS. 10-12.

FIG. 14 illustrates the lid portion of FIGS. 10-13 in an assembled position.

FIG. 15 illustrates a plan view of an alternatively constructed lid portion.

The drawings and detailed description presented herein are not intended to limit the disclosure to any particular embodiment disclosed, but to the contrary, the intention is to cover all modifications, equivalents, and alternatives, including alternative materials, falling within the spirit and scope of the present disclosure as defined by the appended claims.

### DETAILED DESCRIPTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

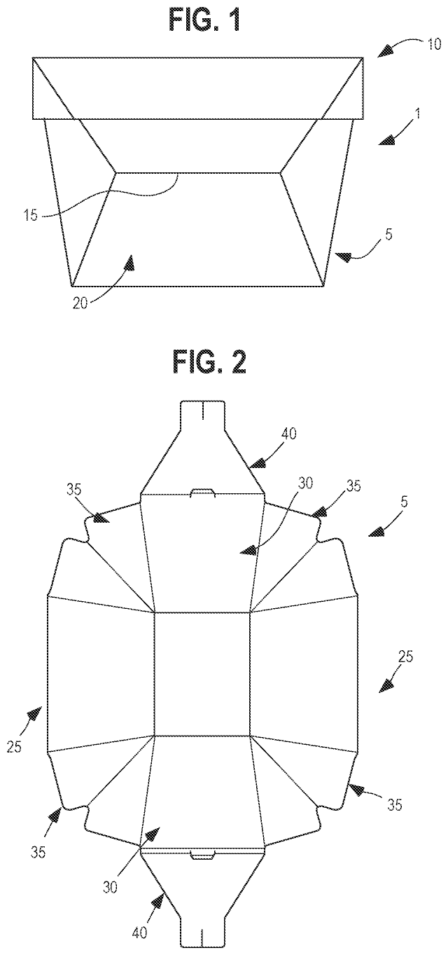

FIG. 1 illustrates a side elevation view of a corrugate cooler 1 constructed according to the teachings hereof. The corrugate cooler 1 generally includes each of a container 5 and a lid portion 10 that is selectively engageable with the container 5. Each of the container 5 and the lid portion 10 may be made from a corrugate cardboard coated with a coating that allows it to be curbside recyclable. The container 5 and the lid portion 10 may each be provided in an unfolded, unconstructed form in some embodiments. However, when constructed, the container 5 and the lid portion 10 together make up the cooler 1. The container 5 is preferably constructed not only to be watertight, but it also is preferably configured to provide handle members 15 on both end portions 20 of the container 5 (only one of which is illustrated in FIG. 1) when constructed.

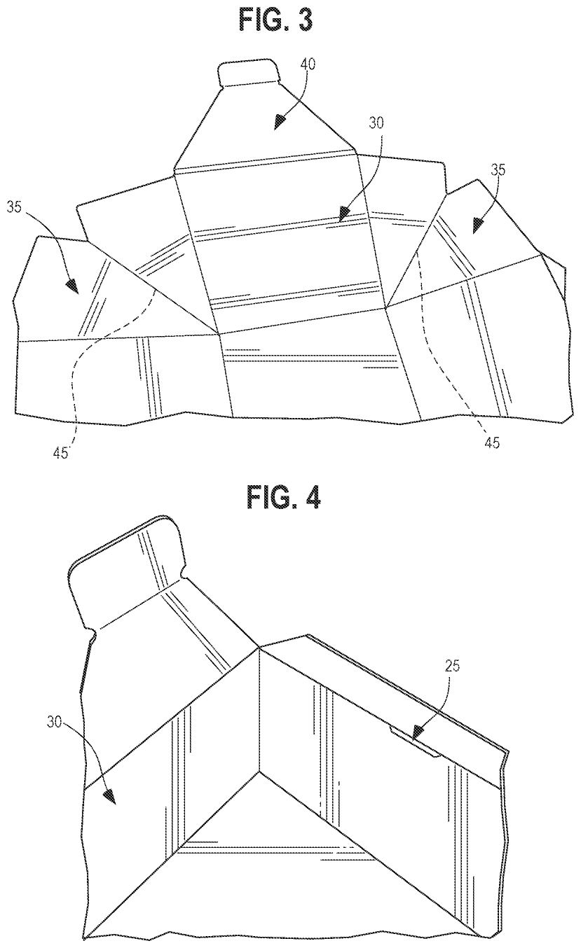

FIG. 2 illustrates the container 5 in its unassembled, unfolded form. As illustrated, the container 5 preferably includes opposing side panels 25 and opposing end panels 30 that extend outwardly from a center panel 32. Four corner panels 35 are preferably located between adjacent side panels 25 and end panels 30. Extension panels 40 preferably extend outwardly from the end panels 30. FIG. 3 illustrates an end panel 30, two corner panels 35, and an extension panel 40 in greater detail. FIG. 3 further provides that each corner panel 35 includes a crease line 45 that substantially halves each corner panel 35.

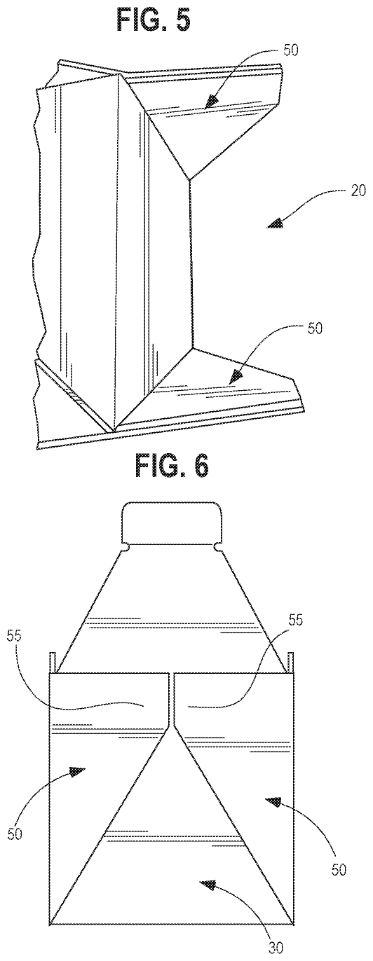

FIGS. 4-13 illustrate various steps that are taken to fold the container 5 into its assembled form. A user may start on either end of the container 5 as described below before moving to the other end. In a first step, corner panels 35 should be folded along the crease lines 45 such that the corner panels 35 are exterior to the side panel 25 and the end panel 30 that are now substantially upright and abutting one another, as illustrated in FIG. 4. Two of the corner panels 35 should be folded accordingly to form rearwardly extending tabs 50 that are illustrated in FIG. 5 on one end portion 20 (it should be noted that the other end portion 20 that is not illustrated in the enlarged FIG. 5 would be folded in substantially the same way).

In a next step illustrated in FIG. 6, the extending tabs 50 may be folded inwardly toward the end panel 30 until they substantially lie flat against the end panel 30. End portions 55 of the extending tabs 50 may nearly abut at or near the center of the end panel 30.

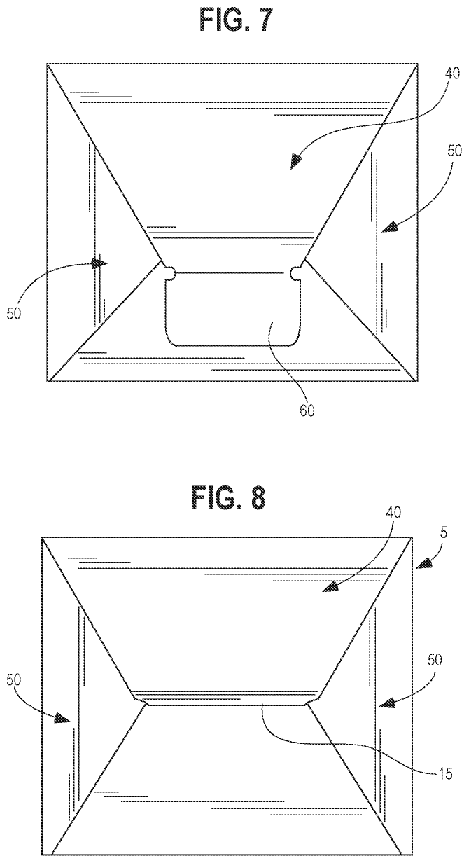

As provided in FIG. 7, a user may next fold the extension panel 40 downwardly over the extending tabs 50. Upon folding the extension panel 40, it preferably abuts the extending tabs 50. Next, a user may fold a locking flap 60 located at a distal portion of the extension panel 40 inwardly and under the extending tabs 50.

FIG. 8 illustrates the locking flap 60 after it has been tucked under the extending tabs 50, and thus the flap 60 itself is not visible. When the flap 60 is tucked under the extending tabs 50 and secured therein, the handle 15 is preferably formed that allows a user to tote the container 5 around.

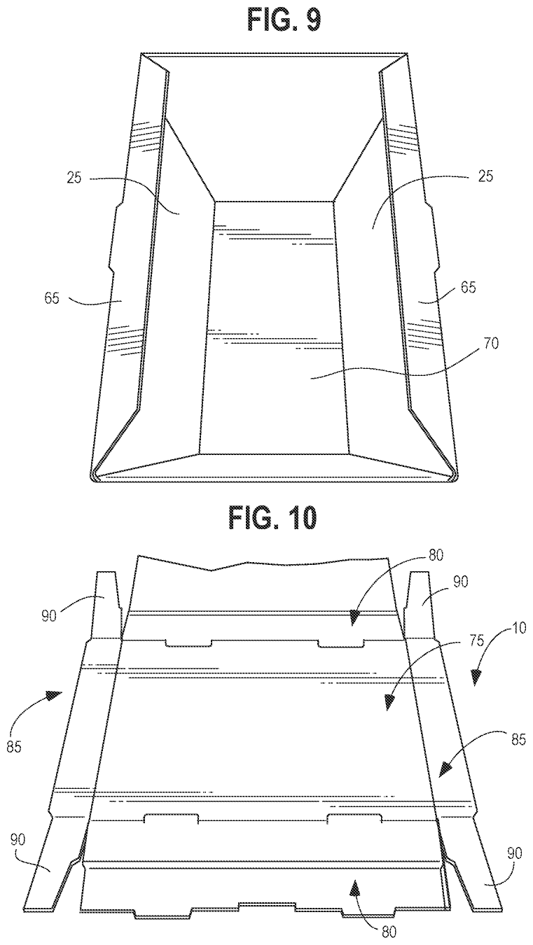

After the first end is assembled using the above-described process, a user may substantially repeat the above-described process to fold the container 5 into its assembled position on the other end. When the user has completed the process on both ends of the container 5, it may be in substantially the form illustrated in FIG. 9. In some embodiments, the opposing side panels 25 may include elongated lid locking tabs 65 that run substantially the length of the side panels 25. In embodiments where the lid locking tabs 65 are included, in a final step to assemble the container 5, the locking tabs 65 (which are illustrated as trapezoidal) may be pushed downwardly to be substantially parallel to a bottom panel 70 formed in the container 5 in which ice and beverage can be placed. The lid locking tabs 65 may help support the lid portion 10 once it is assembled using the process described below. Further, the locking tabs 65 may improve the insulation of the cooler 1 by providing a seal between the container 5 and the lid portion 10.

When the container 5 is constructed, it may be substantially watertight such that water from melted ice or other liquids are unable to leak from the container 5. Put another way, the assembled container 5 does not include cracks, holes, or other apertures that are in communication with the external environment that would cause liquid to leak therethrough when the container 5 is in the upright position.

Because the container 5 may be made from a recyclable material, over time, it may lose its integrity and lead to some leaks. More particularly, in some embodiments, the container 5 may be used approximately five times before the cooler 1 will lose its integrity. The number of uses that the container 5 can withstand may increase or decrease depending on the construction of the container 5. However, when assembled, there are not areas of the container 5 that are inherently prone to leaking.

FIG. 10 illustrates the lid portion 10 in its unassembled position. It should be noted that alternatively constructed lid portions are foreseeable, so long as the alternative lid portion is engageable with the container 5. Because the lid portion 10 serves to cover the container 5, it does not itself support ice, water, and beverage contained in the cooler 1, and as such its construction may vary across embodiments.

In the embodiment illustrated in FIG. 10, the lid portion 10 generally comprises a center panel 75 with side panels 80 and end panels 85 projecting outwardly therefrom. The panels 80, 85 are preferably integrally formed with the center panel 75 and foldable relative thereto. The end panels 85 preferably include minor tab members 90 at their distal portions that are able to fold inwardly toward one another on each end panel 85.

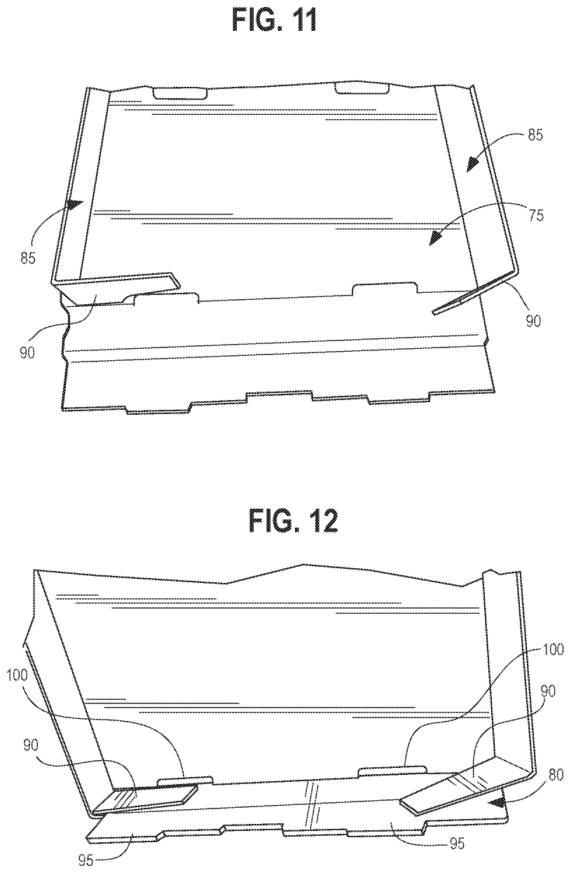

In a first step illustrated in FIG. 11, the end panels 85 are preferably folded toward the center panel 75, and the tab members 90 are preferably folded inwardly toward one another so that they substantially align with the intersection of the center panel 75 and a side panel 80.

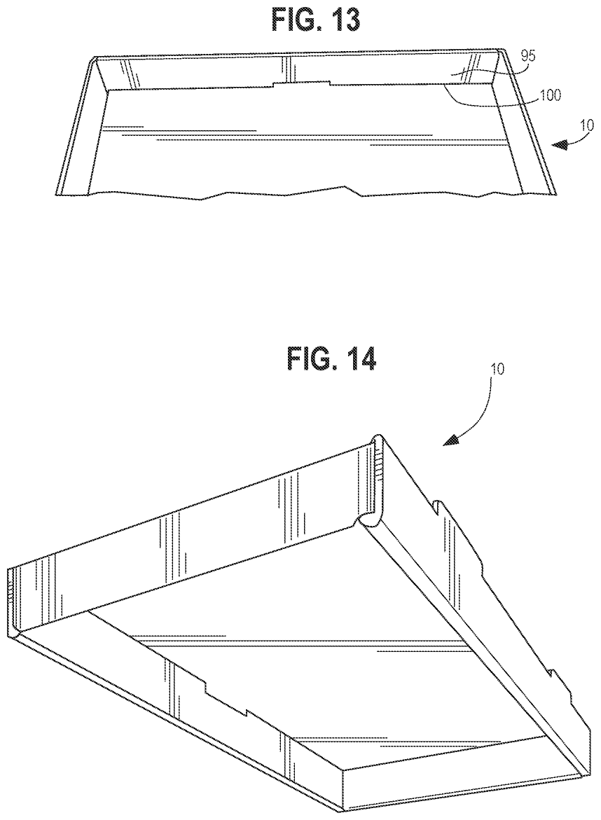

Next, as provided in FIG. 12, a first of the two side panels 80 may be folded over itself such that it covers and secures the tab members 90 within its folded configuration. Projection portions 95 may project from the end of each of the side panels 80. In the illustrated embodiment, each side panel 80 includes two projection portions 95, though more or fewer may be provided in alternative embodiments. When the side panel 80 is folded over itself to retain the tab members 90 in place, the projection portions 95 may align with slot members 100 in the center panel 75 but adjacent to the side panel 80. The slot members 100, of which two are provided in the illustrated embodiment, are configured to receive and retain the projection portions 95. When the projection portions 95 and the slot members 100 are engaged with one another, at least one end of the lid portion 5 is preferably assembled, as illustrated in FIG. 13.

The above process describes the manner in which one end of the lid portion 10 is assembled, but it should be noted that the process can be repeated to fully assemble the lid portion 10. The results of repeating that process are illustrated in FIG. 14, where the lid portion 10 is shown as being fully assembled.

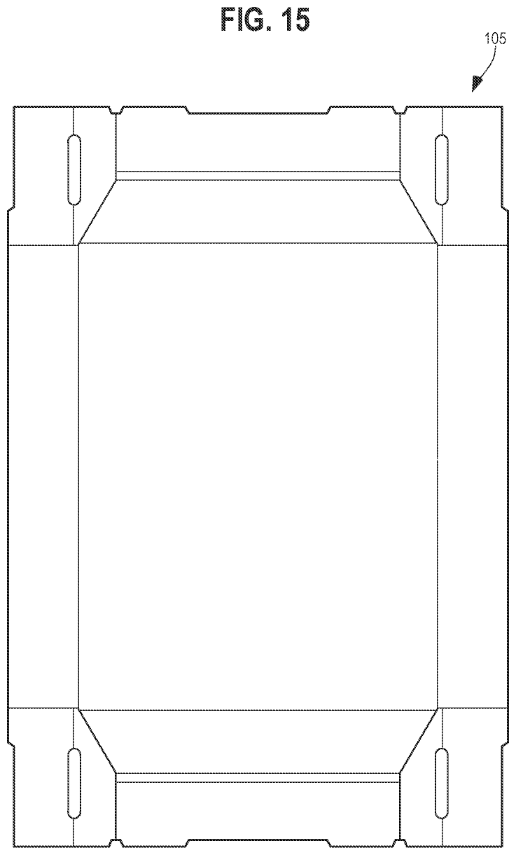

An alternative lid portion 105 is illustrated in FIG. 15. The lid portion 105, like the lid portion 10 may be assembled such that it can mate with the container 5. The lid portion 105 may be assembled in substantially the same manner as the lid portion 10 but may be somewhat differently shaped and sized, as illustrated.

Each of the container 5 and the lid portion 10 (or alternatively constructed container or lid portions) are preferably made from a recyclable cardboard corrugate. The corrugate material (at least for the container 5 but also the lid portion 10 in some embodiments) is preferably coated with a recyclable, fully permeated coating. The coating preferably helps to make the container 5 watertight. Furthermore, the construction of the container 5 and the lid portion 10 preferably eliminate the need for glue or fasteners to hold the container 5 and the lid portion 10 in place.

As is evident from the foregoing description, certain aspects of the present invention are not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. In addition, unless mention was made above to the contrary, it should be noted that all of the accompanying drawings are not to scale. All such changes, modifications, variations and other uses in applications which do not depart from the spirit and scope of the present inventions are deemed to be covered by the inventions which are limited only by the claims which follow.

1. A cooler, the cooler comprising:
a lid portion; and
a container to which the lid portion is releasably engageable, the container including:
a center panel;
two side panels extending outwardly from the center panel;
two end panels projecting outwardly from the center panel;
a corner panel attached to and connected between adjacent side panels and end panels; and
wherein the lid portion and the container are made of a corrugate cardboard material and at least an interior of the container is coated with a recyclable substrate.

2. The cooler of claim 1, further comprising a handle on each of the end panels.

3. The cooler of claim 1, wherein the container is substantially watertight.

4. The cooler of claim 1, wherein a portion of the corner panel overlaps with the adjacent end panel.

5. The cooler of claim 4, wherein each end panel comprises a main body and an extension panel, and wherein the extension panel generally overlaps the main body.

6. The cooler of claim 5, wherein the extension panel overlaps a portion of at least one of the adjacent corner panels.

7. The cooler of claim 6, wherein the end panel is attached to two corner panels, and wherein the extension panel overlaps a portion of each of the two corner panels.

8. The cooler of claim 6, wherein the extension panel further comprises a locking flap positionable under the corner panel.

9. The cooler of claim 1, wherein an upper edge of each side panel terminates in a lid locking tab, and wherein the lid locking tab is substantially parallel with the center panel.

10. The cooler of claim 1, wherein the lid portion comprises:
a lid center panel;
two lid side panels extending outwardly from the center panel; and
two lid end panels extending outwardly from the center panel.

11. The cooler of claim 10, wherein each of the lid end panels comprises a tab member projecting outwardly therefrom and configured to overlap with the adjacent lid side panel.

12. The cooler of claim 11, wherein each of the lid side panels includes a main body and a projection portion, wherein the projection portion substantially overlaps the main body, and wherein the tab member is configured to be received between the main body and the projection portion.

13. The cooler of claim 12, wherein the lid center panel defines slots configured to receive a portion of the projection portion of the lid side panel.

14. A method of assembling a cooler, the method comprising:
providing a cooler comprising a container, the cooler container comprising:
a center panel;
two side panels extending outwardly from the center panel;
two end panels projecting outwardly from the center panel; and
a corner panel attached to and connected between adjacent side panels and end panels;
wherein the container is provided in a substantially planar configuration and at least one side thereof is coated with a recyclable substrate;
folding each corner panel so that at least a portion thereof overlaps with the adjacent end panel;
securing the overlapping portion of the corner panel to the adjacent end panel; and
folding each side panel upward so that each side panel is substantially perpendicular to the center panel.

15. The method of claim 14, further comprising:
providing a lid portion releasably engageable with the cooler container, wherein the lid portion comprises:
a lid center panel;
two lid side panels extending outwardly from the center panel; and
two lid end panels extending outwardly from the center panel;
wherein the lid portion is provided in a substantially planar configuration; and
folding each lid side panel and lid end panel so that the lid side panels and the lid end panels are substantially perpendicular to the lid center panel.

16. The method of claim 15, wherein each lid end panel comprises a tab member projecting outwardly therefrom, and wherein the method further comprises folding each tab member inwardly so that each tab member substantially overlaps the adjacent lid side panel.

17. The method of claim 14, wherein the cooler is substantially watertight.

18. The method of claim 14, wherein each end panel comprises a main body and an extension panel and the method further comprises:
folding the main body upward so that it is substantially perpendicular to the center panel; and
folding the extension panel so that the extension panel overlaps the main body and captures the overlapped corner panel portion therebetween.

19. The method of claim 18, wherein the extension panel further comprises a locking flap and the method further comprises folding the locking flap so that it extends between the overlapped corner panel portion and the main body.

20. The method of claim 14, wherein the cooler is assemblable without using glue or fasteners.
